(19) United States
(12) Patent Application Publication
(10) Pub. No.: US 2019/0161151 A1
(43) Pub. Date: May 30, 2019

(54) RUDDER BLADE WITH A MODULAR STRUCTURE, SEGMENT FOR A RUDDER BLADE OR FOR AN APPARATUS FOR IMPROVING PROPULSION AND METHOD FOR MANUFACTURING A RUDDER BLADE

(71) Applicant: Becker Marine Systems GmbH, Hamburg (DE)

(72) Inventors: Dirk Lehmann, Hamburg (DE); Herbert Blümel, Hamburg (DE)

(73) Assignee: Becker Marine Systems GmbH, Hamburg (DE)

(21) Appl. No.: 16/201,667

(22) Filed: Nov. 27, 2018

(30) Foreign Application Priority Data
Nov. 28, 2017 (EP) 17204181.6

(51) Int. Cl. B63H 25/38; B63B 9/00

(52) U.S. Cl. CPC B63H 25/38; B33Y 80/00; B63B 9/00

(57) ABSTRACT

In order to provide a rudder blade, which has a low level of weight, is easier and more inexpensive to manufacture, that meets the various strength and stability requirements for various rudder-blade sections, which can be at least partly manufactured in an automated manner and for which the manufacturing of irregular surfaces, in particular, the leading edge, is made easier, a rudder blade is proposed, which has a modular structure, wherein the rudder blade comprises at least two prefabricated rudder-blade segments and is composed of the at least two prefabricated rudder-blade segments.

The present invention relates to a rudder blade for a rudder of a watercraft, in particular, for a ship. Furthermore, the present invention relates to a segment for a rudder blade or for an apparatus for improving propulsion, as well as a method for manufacturing a rudder blade.

### PRIOR ART

Water crafts, in particular ships, comprise a rudder that is usually arranged on the stern for changing the direction of travel. A rudder for a water craft comprises a rudder blade, which is swivel-mounted on the ship's body by means of a rudder stock. Rudder blades, in particular for semi-spade rudders or full-spade rudders for water crafts, such as container ships, oil tankers, trawlers, tugboats, ferries or passenger ships, have a high overall weight. In the case of large ships, such as container ships or oil tankers, the overall weight of the rudder can be considerably over 100 tonnes. Even in the case of smaller ships, such as trawlers, tugboats or ferries, a weight in the double-digit tonne range can be reached.

Rudder blades are manufactured in a known way by means of welding a panelling or an outer wall to an inner bare framework or rib structure. A rudder blade is made up of a plurality of sections. A first rudder-blade section can be a main section of a rudder blade, which, in particular, comprises a rudder-blade hub to connect to a rudder stock. Another rudder-blade section can be designed as a front rudder-blade section and can comprise a leading edge of the rudder blade. Furthermore, a rudder blade comprises a rear rudder-blade section, which comprises a trailing edge of the rudder blade or a controllably attached rudder fin on the end side. Thereby, the rear rudder-blade section can be designed as part of the main section.

In the state of the rudder blade arranged on the ship's body, the front rudder-blade section is arranged in the front with reference to a forwards direction of travel of the ship; the rear rudder-blade section or the rudder fin is arranged in the rear with reference to the forwards direction of travel of the ship. Furthermore, a rudder blade can comprise other rudder-blade sections, such as an intermediate section, which, viewed in the forwards direction of travel of the ship, is preferably arranged between the front rudder-blade section and the rear rudder-blade section and is preferably arranged under the main section and above a rudder-blade-bottom section. In the state arranged on the ship, the forwards direction of travel corresponds to a longitudinal direction of the rudder blade.

In particular, in the case of large rudder blades for full-spade rudders or semi-spade rudders, meaning rudder blades that are larger than rudder blades for the smallest of rudders, such as for dinghies or sailboats, manufacturing of the rudder blade by means of panelling a bare framework or ribbed structure is cumbersome. Furthermore, rudder blades that can be manufactured by conventional means are very heavy. In addition to this, the sections of a rudder blade are subject to different strength and stability requirements, which cannot be complied with using known manufacturing methods without making compromises with reference to the final weight. In addition, in particular, full-spade or semi-spade rudders for middle-sized or large ships must be constructed on an individual basis, thereby being cost-intensive. Another known problem exists in that the leading edges of rudder blades are difficult to manufacture by means of conventional welding methods due to changing radii.

### Presentation of the Invention: Object, Solution, Advantages

The object of the present invention is to provide a rudder blade, which has a low level of weight, is easier and more inexpensive to manufacture, meets the various strength and stability requirements for various rudder-blade sections, which can be at least partly manufactured in an automated manner and for which the manufacturing of irregular surfaces, in particular, the leading edge, is made easier. Furthermore, the object of the present invention is to provide a segment for a rudder blade or for an apparatus for improving propulsion, as well as a method for manufacturing a rudder blade or a rudder-blade segment, by means of which the aforementioned advantages can be achieved.

In order to achieve this task, a rudder blade is proposed, wherein the rudder-blade segment comprises a modular construction and wherein the rudder blade comprises at least two prefabricated rudder-blade segments and is composed of the at least two prefabricated rudder-blade segments.

Since the rudder blade comprises at least two prefabricated rudder-blade segments and is composed of these, the individual rudder-blade segments of the at least two rudder-blade segments can be manufactured separately or independently before being assembled into the rudder blade according to the invention. The therefore more favourably designed rudder-blade sections with reference to their weight and their smaller dimensions in comparison to the finished rudder blade can be manufactured using smaller-scale and therefore more inexpensive manufacturing lines. The rudder-blade segments can additionally be better adapted to the stability and strength requirements that apply to them respectively. Furthermore, the individual rudder-blade segments can, for example, be optimized with regard to their weight by using different manufacturing techniques or different materials. An assembly of a rudder blade made of prefabricated rudder blades segments furthermore has the advantage that, if applicable, individual rudder-blade segments can at least partly be manufactured in an automated manner. Furthermore, the segmentation of the rudder blade allows for the use of manufacturing methods, by means of which surfaces can be manufactured, which are difficult to manufacture within the scope of the most recent prior art, in particular, irregular ones, such as leading edges for example, without having to do without the advantages of other manufacturing methods in the case of other rudder-blade sections.

Preferably, the rudder blade is provided for a rudder of a large ship, for example, a container ship, an oil tanker or a passenger ship. Particularly preferably, the rudder surface of the rudder blade is larger than 50 m², furthermore preferably, larger than 70 m², most preferably larger than 90 m², most particularly preferably, larger than 100 m².

Furthermore preferably, the rudder blade according to the invention has a weight of more than 50 t, particularly preferably more than 70 t, most preferably, more than 90 t.

Preferably, the rudder blade is designed as a rudder blade for a full-spade or a semi-spade rudder.

Being advantageous, it can be provided that the rudder blade comprises a main section and a front rudder-blade section with a leading edge, wherein the main section comprises or is a first rudder-blade segment and that the front rudder-blade section comprises or is a second rudder-blade segment.

In the rudder blade, the main section can be a central rudder-blade section, which, in particular, is designed to connect to a rudder stock or a rudder system. In this way, the central rudder-blade section or the main section can comprise a rudder-blade hub for connecting the rudder blade to a rudder stock. The main section can also be referred to as a “main piece” or as a “central rudder-blade section”. It is also possible to refer to the main section as a “rudder blade structure connected with solid parts”.

The front rudder-blade section comprises the leading edge of the rudder blade and is at least partly located in front of the main section of the rudder blade in the state arranged on the ship with reference to a forwards direction of travel. However, the front rudder-blade section can also be at least partly arranged below the main section. If the rudder blade is composed of two rudder-blade segments, a first rudder-blade segment and a second rudder-blade segment, preferably, the main section is identical to the first rudder-blade segment and the front rudder-blade section is identical to the second rudder-blade segment. Preferably, the main section or the first rudder-blade segment can, for example, also comprise the rear rudder-blade section or the trailing edge of the rear rudder-blade section or a rudder fin that is or can be attached to the rudder blade.

However, the main section and the front rudder-blade section must not be designed to be identical to the first rudder-blade section and the second rudder-blade section. For example, the main section and/or the front rudder-blade section can comprise a plurality of rudder-blade segments or a rudder-blade segment is part of both the main section as well as part of the front rudder-blade section.

Since different strength and stability requirements must be complied with for the main section and for the front rudder-blade section of a rudder blade, it is however particularly favourable if the main section comprises or is a first rudder-blade segment and if the front rudder-blade section comprises or is a second rudder-blade segment, wherein the first rudder-blade segment is not part of the front rudder-blade section and the second rudder-blade segment is not part of the main section.

Thereby, both the main section as well as the front rudder-blade section can be formed and constructed freely in accordance with the respectively applicable strength and stability requirements and, if applicable, can be manufactured by means of various manufacturing methods. This makes possible a simple installation, a reduction in manufacturing costs, in the weight and in the required material. Furthermore, the modular construction with a first rudder-blade segment and a second rudder-blade segment makes an at least partial automation of the manufacturing of a rudder blade possible.

Preferably, it can be provided that the rudder blade comprises a rear rudder-blade section with a trailing edge, wherein the rudder blade comprises at least three prefabricated rudder-blade segments and is composed of the at least three prefabricated rudder-blade segments, wherein the rear rudder-blade section comprises or is a third rudder-blade segment.

Furthermore, preferably, it can be provided that the rudder blade comprises an intermediate section, that the rudder blade comprises at least four prefabricated rudder-blade segments and is composed of the at least four prefabricated rudder-blade segments, wherein the intermediate section comprises or is a fourth rudder-blade segment.

If the main section of the rudder blade does not comprise the rear rudder-blade section and/or the trailing edge, an independent rear rudder-blade section can be provided. In the state arranged on the ship and with reference to a forwards direction of travel of the ship, therefore, the front rudder-blade section is located at least partially in front of the main section and the main section is located at least partially in front of the rear rudder-blade section. Thereby, the front rudder-blade section can also comprise a rudder-blade-bottom section, which extends under the main section and, if applicable, under the rear rudder-blade section. The rudder-blade-bottom section is preferably orientated approximately perpendicular to the leading edge. “Approximately perpendicular” is to be understood in that the angle between the leading edge and the rudder-blade-bottom section is between 60° and 90°, preferably between 70° and 90°, more preferably, between 80° and 90°. The angle can also be exactly 90°.

Additionally, if an intermediate section is provided, this can be formed or manufactured out of a fourth rudder-blade segment. The intermediate section can also be called a “semi-flat piece”. The front rudder-blade section can also be called a “curved piece” and the rear rudder-blade section can also be called a “flat piece”.

In a rough schematic side view of the rudder blade, the rudder blade can have the following structure. The front rudder-blade section, comprising the leading edge and a rudder-blade-bottom section, is approximately L-shaped. In a direction viewed in a state arranged on the ship and with reference to a forwards direction of travel of the ship, the main section is located behind the front rudder-blade section and above the rudder-blade-bottom section. Viewed with reference to the forwards direction of travel, the rear rudder-blade section is arranged behind the main section. The rear rudder-blade section is also located above the rudder-blade-bottom section of the front rudder-blade section. Viewed in the longitudinal direction of the rudder blade, the intermediate section is arranged behind the front rudder-blade section and in front of the rear rudder-blade section and, viewed in the vertical direction, it is located under the main section and above the rudder-blade-bottom section of the front rudder-blade section. The L-shaped front rudder-blade section, the rear rudder-blade section and the main section enclose the intermediate section.

However, in principle, more than four rudder-blade sections or rudder-blade segments can also be provided.

Preferably, the at least two rudder-blade segments and/or the rudder-blade sections are connected to each other, wherein the connection takes place by means of gluing, welding, a positive-locking fit or a combination of these methods. Particularly preferably, the second rudder-blade segment and/or the front rudder-blade section is connected to at least one other rudder-blade segment and/or rudder-blade section by means of a glue connection or by means of a combination of a glue connection with a positive-locking fit. The positive-locking fit can take place by means of a click connection or by means of a connection using a profile rail. For the connection of the at least two rudder-blade segments and/or the rudder-blade sections, different connection methods can be used for each connection region. In this way, for example, the first rudder-blade segment or the main section can be connected by means of welding to the third and/or fourth rudder-blade segment, in particular, to the rear rudder-blade section and/or the intermediate section while the second rudder-blade segment, in particular, the front rudder-blade section, can be connected to the other rudder-blade segments or rudder-blade sections by means of gluing or by means of gluing along with a positive-locking fit.

Favourably, it can be provided that at least one rudder-blade segment of the at least two rudder-blade segments comprises another material and/or is made of another material and/or is manufactured by means of another manufacturing method than at least one other rudder-blade segment of the at least two rudder-blade segments, wherein, preferably, the main section, in particular, the first rudder-blade segment, comprises another material and/or is manufactured by means of another manufacturing method than the front rudder-blade section, in particular, the second rudder-blade segment.

By means of using various materials and manufacturing methods for the individual rudder-blade segments, the specific strength and stability requirements for the individual rudder-blade sections and rudder-blade segments can be fulfilled. Furthermore, an automation of the manufacturing method of the rudder blade can be achieved.

Preferably, the front rudder-blade section, in particular, the second rudder-blade segment, comprises a rudder-blade-bottom section and/or the front rudder-blade section comprises a propulsion bulb.

The front rudder-blade section, in particular, the second rudder-blade segment, can comprise a rudder-blade-bottom section and approximately be L-shaped in a side view, wherein the rudder-blade-bottom section is orientated towards the rear viewed with reference to a forwards direction of travel of the ship and is arranged in the lower region of the leading edge of the front rudder-blade section. In particular, the leading edge passes into the rudder-blade-bottom section via a radius in a rounding.

Preferably, it is provided that the main section, in particular, the first rudder-blade segment and/or the front rudder-blade section, in particular, the second rudder-blade segment and/or the rear rudder-blade section, in particular, the third rudder-blade segment and/or intermediate section, in particular, the fourth rudder-blade segment, comprises a curved outer wall.

Furthermore preferably, it can be provided that the rear rudder-blade section, in particular, the rudder-blade segment, comprises a flat outer wall.

In particular, thereby, the rear rudder-blade section or the third rudder-blade segment, which comprises the trailing edge, can comprise a flat outer wall. In this way, the rear rudder-blade section can comprise two flat side walls, which also run into each other towards the trailing edge in approximately a V-shape in a top view. The trailing edge runs along the contact line of the two flat side walls. If the rear rudder-blade section is prefabricated as a third rudder-blade segment, an automation of the manufacturing of a rudder blade is made possible since the flat side walls are particularly suited for automated manufacturing due to the lack of curved outer surfaces, which can only be manufactured with a great deal of effort.

However, it is also possible that the outer wall of the rear rudder-blade section, in particular, of the third rudder-blade segment, is at least partly curved or comprises a kink or is kinked.

Favourably, at least one rudder-blade segment, in particular, the first rudder-blade segment, is a welded construction with transverse ribs and longitudinal ribs.

If the main section of the rudder blade is the first rudder-blade segment, the main section is also a welded construction with transverse and longitudinal ribs. Accordingly, the main section, or the first rudder-blade segment, can be manufactured by means of a known manufacturing method by providing a bare framework or ribbed structure made of transverse and longitudinal ribs and panelling the ribs or the bare framework structure with an outer wall. Such a manufacturing method is particular suited in order to fulfil the stability and strength requirements pertaining to the main section. The main section or the first rudder-blade segment preferably comprises a rudder-blade hub for connection of the rudder blade to a rudder stock. Accordingly, a large part of the rudder forces diverted from the main section. In contrast to the rudders known from the prior art, however, preferably, only the main section or the first rudder-blade segment is designed as a welded construction with transverse and longitudinal ribs while the second rudder-blade segment and, if applicable, the other rudder-blade segments are manufactured by means of other manufacturing methods.

It can preferably be provided that at least one rudder-blade segment, in particular, the second rudder-blade segment, is manufactured by means of a milling method. It can be provided that at least one rudder-blade segment, in particular, the second rudder-blade segment, is designed as a fibre-composite part or a laminate component.

In another particularly preferred embodiment, it is provided that at least one rudder-blade segment, in particular, the second rudder-blade segment, is manufactured by means of a generative manufacturing method and/or an additive manufacturing method, in particular, by means of a 3D-printing method.

Generative manufacturing methods and additive manufacturing methods also comprise methods, which can be referred to as rapid-prototyping methods. In the case of generative and additive manufacturing methods, the manufacturing preferably takes place directly based on computer-based data models and preferably, by means of shapeless liquids, gels, powders or neutrally band-shaped, wire-shaped or sheet material by means of chemical and/or physical processes. Such generative or additive methods are also referred to as 3D-printing methods. In the prior art, a great variety of embodiments for generative, additive or 3D-printing methods are known, for example, a non-exhaustive list includes laser melting, electron beam melting, build-up welding and cladding, stereolithography, laminated object modelling, 3D screen printing and light-controlled electrophoretic deposition or fused deposition modelling.

By using a generative or additive manufacturing method for at least one rudder-blade segment, in particular, for the second rudder-blade segment, furthermore, for the front rudder-blade section in particular, a quick automated and inexpensive manufacturing of a rudder-blade segment, in particular, the second rudder-blade segment, can be made possible. Furthermore, rudder-blade sections can be relatively freely formed. A further advantage of using a generative, additive or 3D-printing method lies in the fact that surfaces which are relatively difficult to manufacture in the prior art, such as the surfaces of a leading edge or irregular surfaces, can be manufactured in an easier and more inexpensive manner.

In a preferred embodiment, the rudder blade comprises a first rudder-blade segment designed as a main section, as well as a second rudder-blade segment designed as a front rudder-blade section, wherein the second rudder-blade segment or the front rudder-blade section comprises a rudder-blade-bottom section and is approximately L-shaped. The main section or the first rudder-blade segment is arranged in the open angle of the L-shaped front rudder-blade section, or of the second rudder-blade segment and is connected to this to form a rudder blade. Thereby, the main section can be manufactured by means of a known manufacturing method as a welded construction with transverse and longitudinal ribs while the front rudder-blade section, in particular, being designed with an L shape, is manufactured by means of a generative, additive or 3D-printing method. Additionally, as is described in the above, the rudder blade can furthermore still comprise other rudder-blade sections, such as a rear rudder-blade section or an intermediate section, which also comprise or are rudder-blade segments.

In another favourable embodiment, it can be provided that at least one rudder-blade segment, in particular, the third rudder-blade segment is a lightweight element.

Favourably, the rear rudder-blade section can be the third rudder-blade segment. Accordingly, the rear rudder-blade section is designed as a lightweight element. Furthermore, the rear rudder-blade section or the third rudder-blade segment is preferably arranged behind the front rudder-blade section and/or behind the main section viewed in the forwards direction of travel of a ship and can furthermore be arranged above a rudder-blade-bottom section of the front rudder-blade section, that is preferably L-shaped.

The rear rudder-blade section or the third rudder-blade segment is particularly suited to be designed as a lightweight element.

Preferably, the rudder-blade segment designed as a lightweight element, in particular the third rudder-blade segment, can be a T-honeycomb component, a panel component or an all-steel honeycomb component.

Instead of ribs of a ribbed structure, in particular, instead of horizontally orientated longitudinal ribs, a T-honeycomb component comprises L- or T-profiles, which are formed into structural elements that are closed in a circumferential direction, being approximately circular, polygonal, or N-sided polygonal in shape, in particular, being octagonal. The opposite sides of the N-sided polygon or octagon must not be mandatorily the same in length; furthermore, the angles between the sides of the N-sided polygon do not all have to be the same. The flanges of the T- or L-profiles form the outer surface of the structural elements. The bars of the T- or L-profiles are orientated in the direction of the interior region enclosed by the flanges and border an opening in the interior region of the respective structural element. The side walls of the rudder-blade segment, in particular, the third rudder-blade segment, are arranged on two opposite regions or sides of the structural elements formed by flanges.

If the rear rudder-blade section is the third rudder-blade segment and is designed as a T-honeycomb component, the side walls, which, in particular are flat, are at an angle to a trailing edge running together with one another and are connected or welded to each other along the trailing edge. Instead of the known ribbed structure consisting of transverse and longitudinal ribs, a framework consisting of L- or T-profiles formed into structural elements extends between the side walls of the rear rudder-blade section arranged in approximately a V-shape.

If the rudder-blade segment, in particular, the third rudder-blade segment, and furthermore in particular the rear rudder-blade section, is a panel component, in particular, this is manufactured by means of the following manufacturing steps:
provision of a first panel plate,
arranging a first number of reinforcement bodies in the first panel plate,
attachment of a first number of reinforcement bodies on the first panel plate to manufacture the first panel,
provision of a second panel plate,
arranging a second number of reinforcement bodies in the second panel plate,
attachment of a second number of reinforcement bodies on the second panel plate to manufacture a second panel,
arrangement of the first panel and the second panel in such a way that the first panel plate and the second panel plate form an outer wall of the rudder blade or rudder-blade segment to be manufactured and that the first number of reinforcement bodies and the second number of reinforcement bodies are orientated in an interior space of the rudder blade or rudder-blade segment to be manufactured,
connecting the first panel and the second panel.

Such a panel component is the object of the European patent application “Method for manufacturing a rudder blade or a rudder-blade segment, rudder blade and rudder-blade segment” of the applicant from the same day of application as the present patent application.

In the third rudder-blade segment designed as a panel component, the reinforcement bodies assume the function of a ribbed structure made of longitudinal and transverse ribs. Thereby, the reinforcement bodies preferably serve to strengthen or to increase the stability or the firmness of the rudder-blade segment. Preferably, the reinforcement bodies can be plates and/or ribs, in particular transverse and/or longitudinal ribs, and/or parts of ribs, in particular, parts of transverse and/or longitudinal ribs.

Furthermore, the panels can preferably be manufactured by means of a welding method, in particular, a robot welding method.

The individual panels can be manufactured on a panel production line and then are joined together by arranging into a rear rudder-blade section or into a third rudder-blade segment.

By means of this, a further automation of the manufacturing method and a reduction in costs are achieved.

If the rudder-blade segment, in particular, the third rudder-blade segment, is designed as an all-steel honeycomb component, a honeycomb component composed of honeycombs abutting each other is located between the side walls of the third rudder-blade segment. The honeycomb structure can have the structure of bee honeycombs. In particular, the longitudinal axes of the honeycombs extend between the side walls. The honeycombs are orientated approximately perpendicularly in relation to a centre plane of the rudder-blade segment, which in the rudder-blade segment's state arranged on the ship is oriented vertically and in a longitudinal direction, which corresponds to the forwards direction of travel of the ship.

Preferably, the leading edge of the front rudder-blade section, in particular, of the second rudder-blade segment, is a twisted or a staggered leading edge.

The rudder blade can, in particular, be designed as a twisted rudder blade, which comprises an upper rudder-blade region and a lower rudder-blade region. The upper rudder-blade region and the lower rudder-blade region each comprise a profile with a suction side and a pressure side. Thereby, the platform is somewhat similar to the profile of an aircraft wing. Thereby, the profile is inverted in the upper rudder-blade region compared to the profile in the lower rudder-blade region, in particular, with reference to the centre plane of the rudder blade. In the case of a twisted rudder, the leading edge of the front rudder-blade section is therefore not designed to be continuous, but the section of the leading edge in the upper rudder-blade region, which is above the propeller hub of the propeller of the ship in the state arranged on the ship of the rudder blade, is offset in relation to the section of the leading edge in the lower rudder-blade region, which is under the propeller hub of the propeller of the ship in the state arranged on the ship, that being in such a way that the upper section of the leading edge is orientated, twisted or offset in the starboard direction while the lower section of the leading edge is orientated, twisted or offset towards the port direction. Depending on the direction of rotation of the propeller, the upper section of the leading edge can also be orientated or twisted or offset towards the port side and the lower section towards the starboard side. In other words, if the suction side is located on the starboard side in the upper rudder-blade region, the suction side is located in the lower rudder-blade region on the port side or vice versa. Accordingly, the pressure side is located in the upper rudder-blade region on the port side and in the lower rudder-blade region on the starboard side or vice versa.

Preferably, it is provided that the front rudder-blade section, in particular, the second rudder-blade segment, comprises a surface with bionic structures.

A bionic structure is a structure that occurs in nature, for example, in the animal or plant realm, which is transferred to technical systems for a certain purpose or objective within a technical context.

Favourably, it is provided that the bionic structure is manufactured by means of a generative manufacturing method and/or an additive manufacturing method, in particular, by means of a 3D-printing method.

Particularly preferably, the surface of the leading edge of the front rudder-blade section or of the second rudder-blade segment is provided with a bionic structure. It is particularly favourable if the rudder-blade segment, in particular the second rudder-blade segment, furthermore the front rudder-blade section in particular, comprising the bionic structure, is manufactured by means of a generative, additive or 3D-printing method. Such manufacturing methods are particularly appropriate for manufacturing bionic structures. In particular, in the case of manufacturing methods known from the prior art, it is not possible to manufacture irregular surfaces, for example, changing radii or bionic structures in an inexpensive manner, and furthermore, relatively difficult to manufacture them at all. The preferred combination of a generative or additive or 3D-printing method along with providing the bionic surface structures, in particular, in the case of a leading edge of a front rudder-blade section or a second rudder-blade segment thereby achieves the benefit of inexpensively providing bionic structures.

The surface with bionic structures can, however, also be provided by means of a material-removing method, for example, by means of a milling method or a casting method. Furthermore, it is also possible to manufacture the bionic structure by means of conventional welding methods. However, preferably, a manufacturing of the bionic structure, in particular the bionic structure of the leading edge of the second rudder-blade segment takes place by means of an additive, generative or a 3D-printing method.

Furthermore, it is naturally also possible that other rudder-blade segments comprise bionic surface structures.

As a further advantage, the bionic structure is designed to reduce a flow resistance and/or to delay a stall, wherein the bionic structure is preferably a sharkskin structure and/or wherein the bionic structure is a fin structure, in particular, a whale-fin structure.

Bionic structures, such as a sharkskin structure or a fin structure, are particularly suited to reduce the flow resistance of the rudder blade and/or to delay a stall.

In addition, preferably at least one of the at least two rudder-blade segments, preferably the first rudder-blade segment and/or the second rudder-blade segment and/or the third rudder-blade segment and/or the fourth rudder-blade segment, comprises at least two sub-segments.

The sub-segments can also be prefabricated and the at least one rudder-blade segment of the at least two rudder-blade segments is composed of the at least two sub-segments. The rudder-blade segment composed of at least two sub-segments is then assembled into a rudder blade using other rudder-blade segments, which also comprise sub-segments or can be composed of these. For example, the main section of the rudder blade, in particular, the first rudder-blade segment is composed of two sub-segments. Preferably, a first sub-segment of the main section or of the first rudder-blade segment is arranged above the propeller hub of the propeller of the ship in the state arranged on the ship and a second sub-segment of the first rudder-blade segment is arranged under the propeller hub of the propeller in the state arranged on the ship. This means that the first sub-segment is also located over the second sub-segment in the state arranged on the ship.

In particular, in the case of twisted rudders, a first rudder-blade segment or a main section composed of at least two sub-segments is favourable. The first sub-segment is then preferably arranged in the upper rudder-blade region, which preferably comprises a leading edge, which is twisted, orientated or offset towards the starboard or port direction, whereas the second sub-segment is arranged in the lower rudder-blade region, which comprises a leading edge, which is twisted, orientated or offset towards the starboard or port direction in an opposing direction to the upper rudder-blade region. By means of designing at least one rudder-blade segment, in particular, the first rudder-blade segment or the main section, out of at least two sub-segments, manufacturing costs can be reduced and simplified manufacturing of the rudder blade can be achieved. In addition, in a simple manner, it is possible to form an upper rudder-blade region and a lower rudder-blade region for a twisted rudder.

However, other rudder-blade segments, for example, the second, the third, the fourth or other rudder-blade segments, can also comprise at least two sub-segments. For example, in this way, also the rear rudder-blade section, the front rudder-blade section or the intermediate section can be composed of at least two sub-segments.

The front rudder-blade section, in particular, the second rudder-blade segment, which is preferably approximately L-shaped and comprises a rudder-blade-bottom section, can, in particular, preferably comprise at least two sub-segments or be composed of at least two sub-segments. In this way, being particularly advantageous, it is possible that the rudder-blade-bottom section is composed of a plurality of sub-segments that are manufactured by means of an additive, generative or a 3D-printing method. Another sub-segment can be designed as a propulsion bulb.

It is also possible that the front rudder-blade section, in particular, the second rudder-blade segment, comprises sub-segments, wherein a first sub-segment comprises an upper section of the leading edge. The upper section of the leading edge is arranged above the propeller hub in the state arranged on the ship. The upper section of the leading edge is, for example, is offset, twisted or orientated in the starboard direction. A second sub-segment can comprise a lower section of the leading edge. The lower section of the leading edge is arranged under the propeller hub in the state arranged on the ship. The upper section of the leading edge is, for example, is offset, twisted or orientated in the port direction.

Being furthermore favourable, the first rudder-blade segment comprises a first sub-segment and a second sub-segment and is composed of the first sub-segment and the second sub-segment, wherein, preferably, a connecting body, in particular, a stabilization plate, is arranged between the first sub-segment and the second sub-segment.

A connecting body arranged between the first sub-segment and the second sub-segment of the first rudder-blade segment serves to connect the first and the second sub-segment and additionally increases the stability of the first rudder-blade segment, in particular, of the main section. In particular, in the case of a twisted rudder, where the first sub-segment and the second sub-segment have an essentially inverted profile shape, providing a connecting body as well as a stabilization plate particularly favourable.

Another solution to the problem the invention is based on lies in providing a rudder-blade segment for a rudder blade described in the above.

Furthermore, achieving the task at hand based on the object of invention entails providing a segment for a rudder blade or for an apparatus for improving propulsion, in particular, a rudder-blade segment or a nozzle segment, wherein the segment is manufactured by means of a generative manufacturing method and/or an additive manufacturing method, in particular, a 3D-printing method.

The segment can be part of a complete rudder blade or a complete apparatus for improving propulsion. However, the segment can also be designed as a complete rudder blade or as a complete apparatus for improving propulsion and, in particular, can be identical to a complete rudder blade or a complete apparatus for improving propulsion.

The segment can be a rudder-blade segment, in particular, for a rudder with a modular construction described in the above. Furthermore, the segment can also be a segment for an apparatus for improving propulsion. Such apparatuses are, for example, designed as pre-nozzles, Kort nozzles, Mewis Duct nozzles or propeller nozzles. Apparatuses for improving propulsion characteristics also comprise leading edges just like rudder blades. Furthermore, the segment can also be designed as a fin or stabilization fin. In particular, fins are used in nozzles, such as Kort nozzles, Mewis Duct nozzles, pre-nozzles or propeller nozzles and are usually arranged in the interior space of the nozzle. However, fins can also be arranged on the outer side of the nozzle. Fins are usually arranged orientated outwardly in the radial direction by a central centre axis in the direction of a nozzle casing or by an outer wall of the nozzle casing of the nozzle. Furthermore, fins comprise a profile shape, which is ideal for influencing a water flow. In particular, fins are equipped with a suction side and a pressure side. A turbulence in the flow of a propeller can be rectified by means of fins arranged behind a propeller. By means of this, energy can be recovered and propulsion characteristics can be improved. Furthermore, fins can also be arranged in front of the propeller, especially in a pre-nozzle. The fins generate a pre-whirl in the water flowing onto the propeller, whereby energy can also be saved and the propulsion characteristics can be improved. Fins or stabilizing fins also have a leading edge.

Preferably, the segment is a rudder-blade segment, in particular, a front rudder-blade section or a front nozzle section.

Furthermore, the segment preferably comprises a leading edge.

It is particularly favourable if the segment is designed as a rudder-blade segment for a front rudder-blade section and comprises a leading edge. Such rudder-blade segments can only be manufactured with great difficulty and high costs using known methods. In particular, it is difficult to manufacture a leading edge with changing radii using a known welding method. By manufacturing the rudder-blade segment by means of an additive, generative or 3D-printing method, a front rudder-blade section with a leading edge, in particular, with changing radii, can be manufactured in a simple an inexpensive manner and be freely formed independently of strength aspects.

If the segment is designed as a front nozzle section, the leading edge is designed to be bent in a circular manner.

Furthermore, it can be provided that the segment is a rudder-blade segment and comprises a propulsion bulb.

The propulsion bulb can also be prefabricated as a sub-segment, for example, by means of a 3D-printing method, and be assembled into a rudder-blade segment, in particular, for a rudder blade described above using another sub-segment, which is also prefabricated. The rudder-blade segment manufactured in such a way favourably forms a front rudder-blade section of a rudder-blade section described above.

Furthermore, preferably the segment comprises a surface with bionic structures.

Particularly preferably, it is provided that bionic structures are designed to reduce a flow resistance, wherein the bionic structure is preferably a sharkskin structure and/or wherein the bionic structure is a fin structure, in particular, a whale-fin structure.

Such bionic structures are particularly suited to reduce flow resistance.

Especially preferably, the bionic structure is arranged on a surface of a leading edge.

Furthermore, preferably the bionic structures are manufactured by means of a generative manufacturing method and/or an additive manufacturing method, in particular, by means of a 3D-printing method, and/or by means of a material-removal method, in particular a milling method, and/or by means of a casting method.

Thereby, it is of a particular advantage if a generative, additive or 3D-printing method is used for manufacturing the bionic structures of the segment. The surface of the segment, in particular, the leading edge, preferably comprises bionic structures. The segment is manufactured by means of a 3D-printing method or an additive or generative manufacturing method, wherein, in the case of manufacturing the segment by means of the additive, generative or 3D-printing method, the bionic structures, in particular, on the leading edge, are also manufactured.

Having a furthermore advantage, the segment comprises at least two sub-segments, and/or the segment is composed of at least two sub-segments.

By means of assembling sub-segments, in particular prefabricated ones, into a segment for a rudder blade or for an apparatus for improving propulsion, the manufacturing of such segments can be further simplified and manufacturing costs can be reduced.

Particularly preferably, a segment comprising at least two sub-segments or composed of at least two sub-segments is designed as a second rudder-blade segment for a rudder blade described above. This second rudder-blade segment can be designed as a front rudder-blade section for a modular rudder blade described above and can comprise a first upper region with a leading edge as well as lower second region orientated approximately perpendicular to the first region. The second region is favourably a rudder-blade-bottom section and passes over into the first region in a radius and is orientated approximately perpendicular to the first region so that the rudder-blade segment is approximately L-shaped. “Approximately perpendicular” is to be understood in that the angle between the first upper region to the leading edge and the second lower region, the rudder-blade-bottom section, is between 60° and 90°, preferably between 70° and 90°, more preferably, between 80° and 90°. The angle can also be exactly 90°.

If the segment is designed as a nozzle segment for a nozzle, the sub-segments can comprise a leading edge or sections of a leading edge. A sub-segment of the nozzle segment can correspond to a sixteenth, an eighth, a fourth or a half or even the complete extent of the nozzle or an inlet opening of the nozzle.

It is particularly favourable if the sub-segments are connected to each other, in particular by means of a click-fastening system, by means of gluing, screwing together or welding.

If the sub-segments are manufactured by means of a generative, additive or 3D-printing method, these can comprise a click-connection system in a particularly favourable manner and be capable of connecting to each other into a rudder-blade segment or a nozzles segment by means of the click-connection system.

A connection of the sub-segments by means of gluing and/or screwing together is also particularly favourable in the case of sub-segments manufactured by means of an additive, generative or a 3D-printing method.

Furthermore, it can be provided that the segment is designed as a front rudder-blade section and comprises a rudder-blade-bottom section.

Particularly preferably, it is provided that the rudder-blade-bottom section is composed of sub-segments.

The sub-segments of the rudder-blade-bottom section can be joined by means of a click-fastening system, by means of gluing, screwing together or welding.

In a favourable embodiment, it is provided that the sub-segments are approximately U-shaped and comprise a recess or a groove running in a longitudinal direction to connect to another segment.

Sub-segments, which are approximately U-shaped can be assembled into a rudder-blade-bottom section by means of a click-connection system, by means of gluing, screwing together or welding in a particularly favourable manner. The recess or groove preferably serves to receive another rudder-blade segment, such as a main section described above or an intermediate section described above for example.

For this purpose, the corresponding rudder-blade segment comprises a rib or a flange or a spring that is complementary to the recess or to the groove, which can engage into the recess or the groove and, in particular, result in a lateral positive-locking fit. The rudder-blade segment assembled from sub-segments, which is designed for a front rudder-blade section, can be assembled into a rudder blade with a modular construction using other rudder-blade segments. Furthermore, the connection between the other rudder-blade segments and the rudder-blade segment can additionally or alternatively take place by means of a click-connection system, by means of gluing or welding or screwing together.

Being furthermore favourable, it can be provided that the sub-segments comprise a first face side and a second face side, wherein connection means are arranged in the first face side and the second face side to connect two sub-segments to their face sides respectively.

In other words, the sub-segments with their face sides can be joined to each other in such a way that the connection means of the first face side of the first sub-segment and the connection means of the second face side of the second sub-segment come into connecting contact with one another or are brought into connecting contact with one another so that the sub-segments are assembled into a single segment, in particular, into a rudder-blade segment.

Furthermore, it can be provided that the recess or groove does not centrally run within the sub-segment.

Another solution to the problem the invention is based on lies in providing a method for manufacturing a rudder blade with a modular structure comprising the steps:
manufacturing a first rudder-blade segment,
manufacturing a second rudder-blade segment,
joining of at least the first rudder-blade segment and the second rudder blade segment.

Furthermore, it can be provided that other rudder-blade segments, in particular a third and/or a fourth rudder-blade segment, can be assembled to form a rudder blade with a modular design using the first rudder-blade segment and the second rudder-blade segment. Thereby, the rudder-blade segments can be designed according to the rudder-blade segments described above, in particular, the rudder-blade segments described above for a modular rudder blade.

Preferably, it is provided that the first rudder-blade segment is a main section of a rudder blade and/or that the second rudder-blade segment is a front rudder-blade section.

Furthermore preferably, it can be provided that a third rudder-blade segment is a rear rudder-blade section and/or that a fourth rudder-blade section is an intermediate section of a rudder blade to be manufactured.

Particularly preferably, it can be provided that the first rudder-blade segment is manufactured by means of a welding method by panelling a bare framework structure made of transverse and longitudinal ribs.

Furthermore preferably, it can be provided that the second rudder-blade segment is manufactured by means of a generative manufacturing method and/or an additive manufacturing method, in particular, by means of a 3D-printing method.

### BRIEF DESCRIPTION OF THE FIGURES

The present invention is described in detail below with reference to the drawings. The figures show

FIG. 1 a perspective view of a rudder blade with a modular structure,

FIG. 2 an exploded view of a rudder blade with a modular structure.

FIG. 3 a rudder-blade segment designed as a front rudder-blade section,

FIG. 4 a structured surface with bionic structures,

FIG. 5 a rudder-blade segment designed as a main section with a first sub-segment and a second sub-segment,

FIG. 6 a perspective view of a sub-segment for a rudder-blade-bottom section.

FIG. 7a a front view of a sub-segment for a rudder-blade-bottom section,

FIG. 7b a back view of a sub-segment for a rudder-blade-bottom section,

FIG. 8a a top view of a sub-segment for a rudder-blade-bottom section, and

FIG. 8b a side view of a sub-segment for a rudder-blade-bottom section,

### DETAILED DESCRIPTION OF THE FIGURES

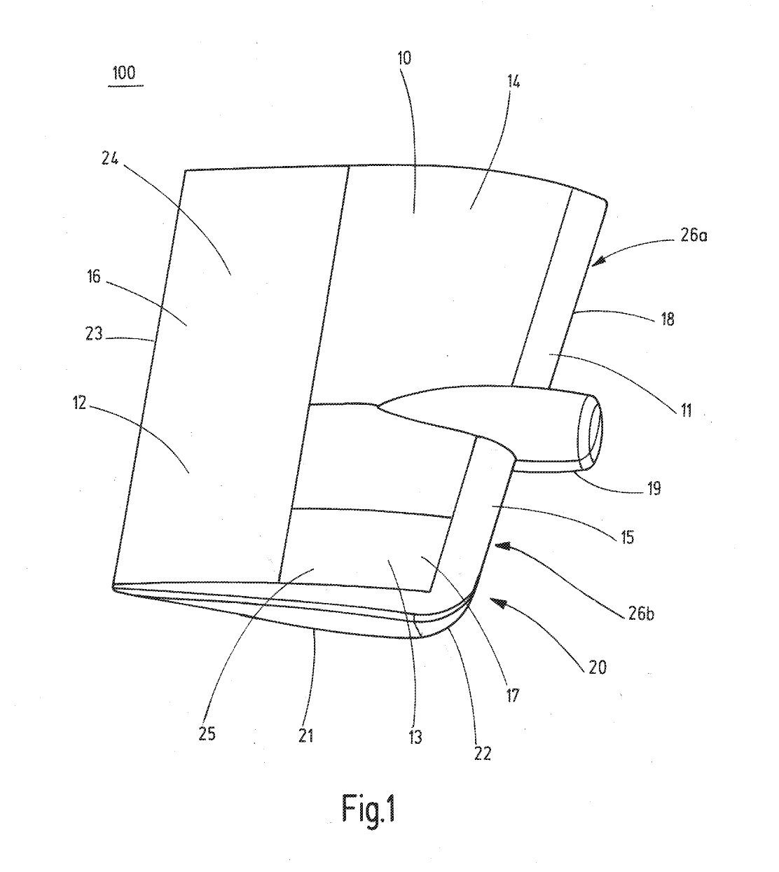

FIG. 1 shows a perspective view of a rudder blade 100 with a modular structure. The rudder blade 100 comprises prefabricated rudder-blade segments 10, 11, 12, 13 and is composed of the prefabricated rudder-blade segments 10, 11, 12, 13. A first rudder-blade segment 10 is designed as a main section 14. A second rudder-blade segment 11 is designed as a front rudder-blade section 15. A third rudder-blade segment is designed as a rear rudder-blade section 16. A fourth rudder-blade segment 13 is designed as an intermediate section 17. The front rudder-blade section 15 comprises a leading edge 18 as well as propulsion bulb 19. The second rudder-blade segment 11 or the front rudder-blade section 15 is approximately L-shaped, wherein a rudder-blade-bottom section 21 adjoins in the lower region 20. The rudder-blade-bottom section 21 is orientated at approximately a right angle to the section of the second rudder-blade segment 11, at which the leading edge 18 is arranged and passes over into this section via a radius 22. The rudder-blade-bottom section 21 can be designed as a single piece with the second rudder-blade segment 11, which represents the front rudder-blade section 15. However, it is also possible that the rudder-blade-bottom section 21 is an independent rudder-blade segment. The third rudder-blade segment 12 comprises a trailing edge 23. The outer walls 24 of the rear rudder-blade section 16 and of the third rudder-blade section 12 are designed to be flat. The fourth rudder-blade segment designed as an intermediate section 17, which can also be called a “semi-flat piece”, primarily comprises slightly curved outer walls 25. In the arrangement shown, the first rudder-blade segment 10, the second rudder-blade segment 11 and third rudder-blade segment 12 enclose the intermediate section 17 and the fourth rudder-blade segment 13. The rudder 100 shown is a twisted rudder. That means that the upper section 26a of the leading edge 18 is offset with relation to a lower section 26b of the leading edge 18 so that the upper section 26a is offset in the port direction while the lower section 26b is offset in the starboard direction.

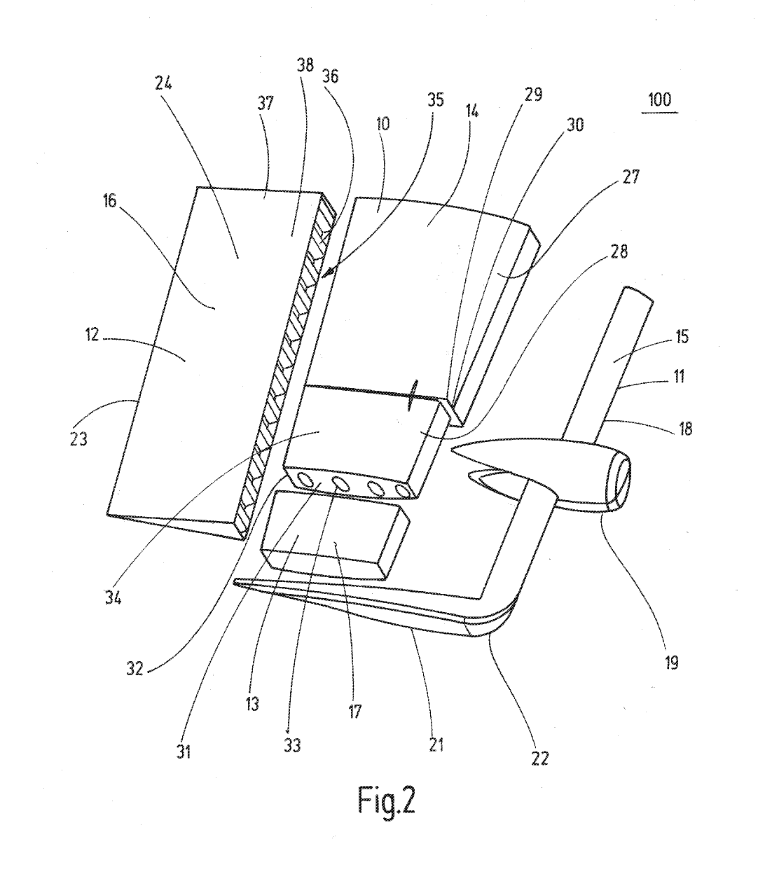

FIG. 2 shows an exploded view of the rudder 100 with a modular structure. The second rudder-blade segment 11, which is designed as a front rudder-blade section 15, comprises the leading edge 18, the propulsion bulb 19 as well as the rudder-blade-bottom section 21. The first rudder-blade segment 10, which is designed as a main section 14, is composed of a first sub-segment 27 and a second sub-segment 28. The first sub-segment 27 and the second sub-segment 28 are connected to each other via a connecting body 30 designed as a stabilization plate 29. A longitudinal rib 32 can be seen on the bottom 31 of the second sub-segment 28 of the main section 14. The main section 14 or the first rudder-blade segment 10 composed of the first sub-segment 27 and the second sub-segment 28 is manufactured by means of a conventional manufacturing method by means of panelling of a bare framework structure 33 with an outer wall 34 made of longitudinal ribs 32 and transverse ribs.

In contrast, the second rudder-blade segment 11, which forms the front rudder-blade section 15, is manufactured by means of a an additive or a generative manufacturing method, in particular, by means of a 3D-printing method.

The third rudder-blade segment 12 designed as a rear rudder-blade section 16 comprises an all-steel honeycomb component 36 in an interior space 35 so that the third rudder-blade segment 12 is designed as a lightweight element 37. The fourth rudder-blade segment 13 designed as an intermediate section 17 can be manufactured by means of a conventional manufacturing method by panelling a bare framework structure, by means of a 3D-printing method or by means of other methods.

Due to the different manufacturing methods, the materials of the rudder-blade segments 10, 11, 12, 13 are different. In this way, the second rudder-blade segment 11 manufactured by means of a 3D-printing method can be made of a plastic or a metal. In contrast, the main section 14 manufactured by means of a known manufacturing method is manufactured out of steel. The rear rudder-blade section 16 can also be manufactured by means of a conventional or known manufacturing method. However, it is also possible that the rear rudder-blade section 16 is manufactured out of a plastic or comprises a plastic.

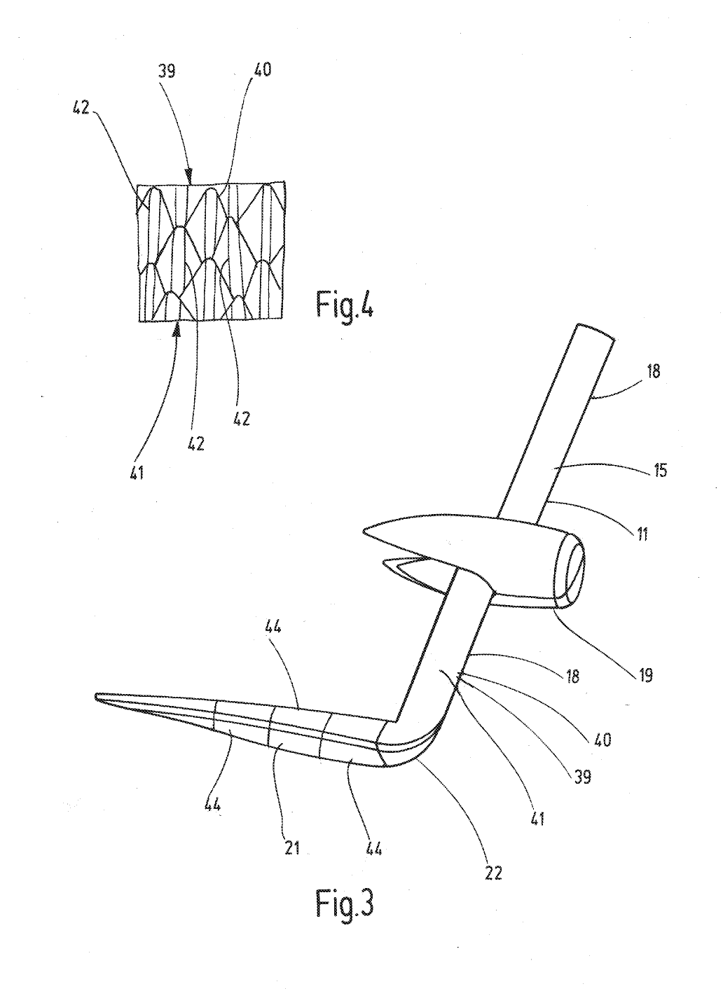

FIG. 3 shows a perspective view of the second rudder-blade segment 11 designed as a front rudder-blade section 15. In the embodiment shown in FIG. 3, the second rudder-blade segment 11 comprises a structured surface 39. In particular, the leading edge 18 is provided with the structured surface 39. The structured surface 39 thereby comprises bionic structures 40. The bionic structures 40 can, for example, be designed as a sharkskin structure 41.

A section of the structured surface 39 of the leading edge 18 is shown in FIG. 4 in a detailed view. The bionic structure 40 comprising a sharkskin structure 41 comprises a plurality of elevations 42.

The structured surface 39 and the bionic structure 40 of the leading edge 18 of the second rudder-blade segment 11 is favourably manufactured at the same time during the same manufacturing step as the second rudder-blade segment 11 by means of a generative, additive or 3D-printing method. The bionic structures 40 must not be subsequently machined out of the second rudder-blade segment 11, for example by means of a milling method.

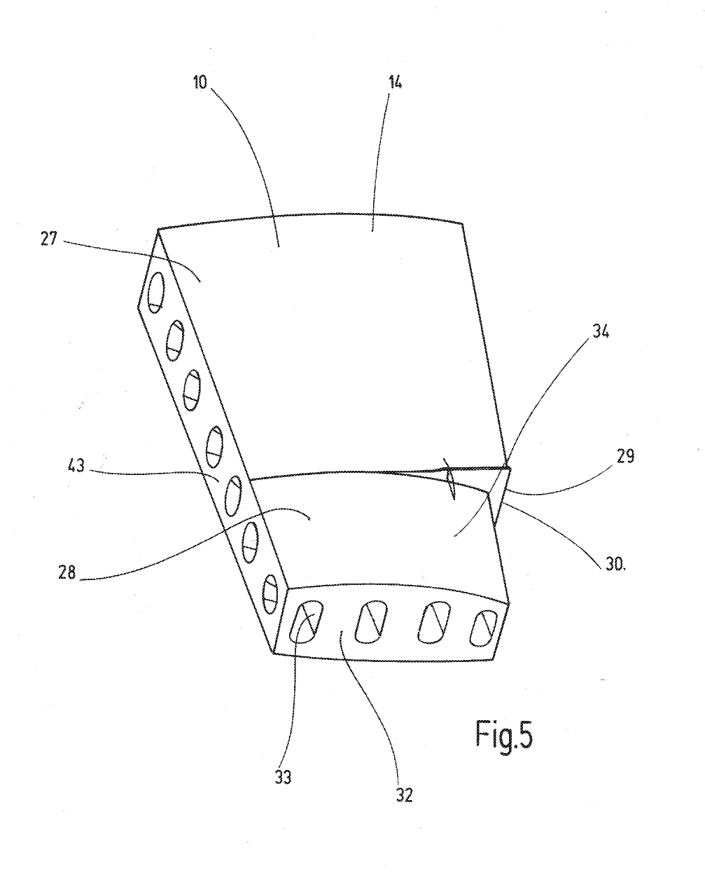

FIG. 5 shows a perspective view of the main section 14. The main section 14 is composed of a first sub-segment 27 and a second sub-segment 28, which are connected to each other via a stabilization plate 29. In the interior space of the main section 14, a bare framework structure 33 made of longitudinal ribs 32 and transverse ribs 43 are arranged, which is provided with an outer wall 34.

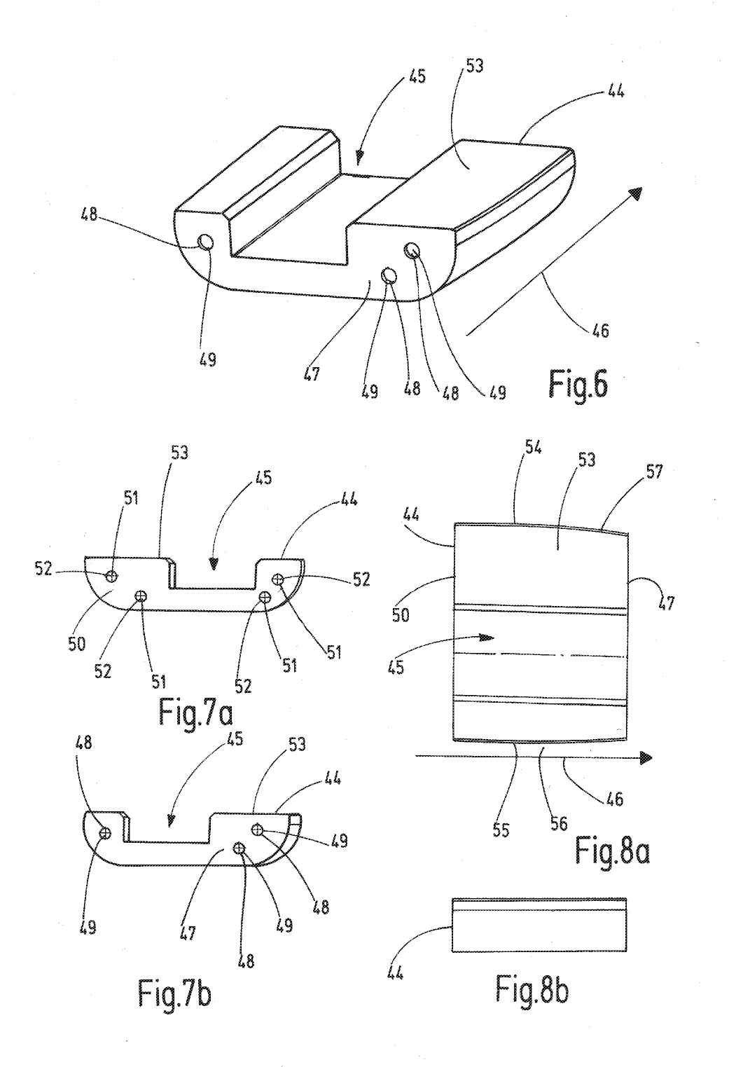

Returning to the FIG. 3, it can be recognized that the rudder-blade-bottom section 21 of the second rudder-blade segment 11 is also composed of a plurality of sub-segments 44. A sub-segment 44 of the rudder-blade-bottom section 21 is shown in a perspective view in FIG. 6. The sub-segment 44 of the rudder-blade-bottom section 21 is approximately U-shaped and comprises a recess or a groove 45, which runs in a longitudinal direction 46 of the sub-segment 44. Thereby, the groove 45 is not centrally arranged, but runs slightly offset within the sub-segment 44. A first face side 47 of the sub-segment 44 comprises connection means 49 designed as receiving openings 48.

In FIGS. 7a and 7b, the sub-segment 44 is shown in a front view (FIG. 7a) and in a back view (FIG. 7b). In the front view a second face side 50 of the sub-segment 44 is shown. Connection means 52 designed as receiving openings 51 are also located in the second face side 50. In the back view shown in FIG. 7b, the connection means 49 are shown again in the first face side 47.

FIGS. 8a and 8b show a top view (FIG. 8a) and a side view (FIG. 8b) of the sub-segment 44. The groove 45 in the upper side 53 of the sub-segment 44, which is not centrally arranged, can be clearly recognized. A plurality of sub-segments 44 can be arranged in such a way that a first face side 47 of a first sub-segment 44 comes to rest in contact with a second face side 50 of the second sub-segment 44. Snap hooks or click-connection elements or, if applicable, screws (all not shown) can be led into the receiving openings 48, 51, thereby connecting a plurality of sub-segments 44 with each other to form a rudder-blade-bottom section 21.

The sub-segment 44 is also manufactured as part of the second rudder-blade segment 11 by means of a 3D-printing method. The material is preferably PET-G or ABS. In the top view in FIG. 8a, it can furthermore be recognized that the contour of a first side 54 is more strongly curved than the contour of a second side 55 lying opposite to the first side 54. The different contour corresponds to the different contour of the side of the rudder blade 100, which is designed as a twisted rudder, thereby comprising a pressure side 56 and a suction side 57.

### LIST OF REFERENCE NUMBERS

100 rudder blade
10 first rudder-blade segment
11 second rudder-blade segment
12 third rudder-blade segment
13 fourth rudder-blade segment
14 main section
15 front rudder-blade section
16 rear rudder-blade section
17 intermediate section
18 leading edge
19 propulsion bulb
20 lower area
21 rudder-blade-bottom section
22 radius
23 trailing edge
24 outer wall
25 outer wall
26a upper section
26b lower section
27 first sub-segment
28 second sub-segment
29 stabilization plate
30 connecting body
31 bottom
32 longitudinal rib
33 bare framework structure
34 outer wall
35 interior space
36 honeycomb element
37 lightweight element
38 panel
39 structured surface
40 bionic structure
41 sharkskin structure
42 projection
43 transverse rib
44 sub-segment
45 groove
46 longitudinal direction
47 first face side
48 receiving opening
49 connection means
50 second face side
51 receiving opening
52 connection means
53 upper side
54 first side
55 second side
56 pressure side
57 suction side

1. A rudder blade having a modular structure, wherein the rudder blade comprises at least two prefabricated rudder-blade segments and is composed of the at least two prefabricated rudder-blade segments.

2. The rudder blade according to claim 1, wherein the rudder blade comprises a main section and a front rudder-blade section with a leading edge, wherein the main section comprises or is a first rudder-blade segment and wherein the front rudder-blade section comprises or is a second rudder-blade segment,
and/or wherein the rudder blade comprises a rear rudder-blade section with a trailing edge, wherein the rudder blade comprises at least three prefabricated rudder-blade segments and is composed of the at least three prefabricated rudder-blade segments, wherein the rear rudder-blade section comprises or is a third rudder-blade segment, and/or wherein the rudder blade comprises an intermediate section, wherein the rudder blade comprises at least four prefabricated rudder-blade segments and is composed of the at least four prefabricated rudder-blade segments, wherein the intermediate section comprises or is a fourth rudder-blade segment.

3. The rudder blade according to claim 1, wherein at least one rudder-blade segment of the at least two rudder-blade segments (10, 11, 12, 13) comprises another material and/or is made of another material and/or is manufactured by means of another manufacturing method than at least one other rudder-blade segment of the at least two rudder-blade segments, wherein, preferably, the main section, in particular, the first rudder-blade segment, comprises another material and/or is manufactured by means of another manufacturing method than the front rudder-blade section, in particular, the second rudder-blade segment.

4. The rudder blade according to claim 2 or 3, wherein the front rudder-blade section, in particular, the second rudder-blade segment, comprises a rudder-blade-bottom section, and/or that the front rudder-blade section comprises a propulsion bulb.

5. The rudder blade according to claim 1, wherein at least one rudder-blade segment, in particular, the first rudder-blade segment, is a welded construction with transverse ribs and longitudinal ribs, and/or that at least one rudder-blade segment, in particular the second rudder-blade segment, is manufactured by means of a generative manufacturing method and/or an additive manufacturing method, in particular, a 3D-printing method, and/or that at least one rudder-blade segment, in particular the third rudder-blade segment, is a lightweight element, wherein the lightweight construction element is preferably a T-honeycomb component, a panel component or an all-steel honeycomb component.

6. The rudder blade according to claim 2, wherein the front rudder-blade section, in particular the second rudder-blade segment, comprises a surface with bionic structures, wherein, preferably, the bionic structure is designed to reduce a flow resistance, wherein particularly preferably the bionic structure is a sharkskin structure and/or wherein the bionic structure is a fin structure, in particular a whale-fin structure.

7. The rudder blade according to claim 1, wherein at least one of the at least two rudder-blade segments, preferably the first rudder-blade segment and/or the second rudder-blade segment and/or the third rudder-blade segment and/or the fourth rudder-blade segment, comprises at least two sub-segments, wherein, preferably, the first rudder-blade segment comprises a first sub-segment and a second sub-segment, and is composed of the first sub-segment and the second sub-segment, wherein, particularly preferably, a connecting body is arranged between the first sub-segment and the second sub-segment, being a stabilization plate in particular.

8. (canceled)

9. A segment for a rudder blade or for an apparatus for improving propulsion, in particular, a rudder-blade segment or a nozzle segment, wherein the segment is manufactured by means of a generative manufacturing method and/or an additive manufacturing method, in particular, a 3D-printing method, wherein the segment preferably comprises a leading edge.

10. The segment according to claim 9, wherein the segment comprises a surface with bionic structures, wherein the bionic structures are preferably designed to reduce a flow resistance, wherein the bionic structure is, particularly preferably, a sharkskin structure and/or wherein the bionic structure, is a fin structure, in particular a whale-fin structure, wherein, most preferably, the bionic structures are manufactured by means of a generative manufacturing process and/or an additive manufacturing method, in particular, by means of a 3D-printing method and/or by means of a material-removal method, in particular, a milling method and/or by means of a casting method.

11. The segment according to claim 9 or 10, wherein the segment comprises at least two sub-segments and/or that the segment is composed of at least two sub-segments, wherein, preferably, the sub-segments are connected to each other, in particular, using a click fastener system, by means of gluing, screwing together or welding.

12. The segment according to claim 9, wherein the segment is designed as a front rudder-blade section and comprises a rudder-blade-bottom section.

13. The segment according to claim 12, wherein the rudder-blade-bottom section is composed of sub-segments, wherein the sub-segments are preferably designed with a U-shape and comprise a recess or groove running in a longitudinal direction for connection to another segment, and/or wherein the sub-segments (44) comprise a first face side and a second face side, wherein connection means are arranged in the first face side and the second face side to connect two sub-segments to the face sides respectively.

14. A method for manufacturing a rudder blade with modular constructions, comprising the steps:
manufacturing a first rudder-blade segment,
manufacturing a second rudder-blade segment,
joining at least the first rudder-blade segment and the second rudder-blade segment.

15. The method according to claim 14, wherein the first rudder-blade segment is a main section of a rudder blade and/or that the second rudder-blade segment is a front rudder-blade section, and/or that the first rudder-blade segment is manufactured by means of a welding method by panelling a bare framework structure composed of transverse ribs and longitudinal ribs and/or that the second rudder-blade segment is manufactured by means of a generative manufacturing method and/or an additive manufacturing method, in particular, a 3D-printing method.
